(19) United States
(12) Patent Application Publication
(10) Pub. No.: US 2011/0048758 A1
(43) Pub. Date: Mar. 3, 2011

(54) Flat panel mounting interface element, system and method

(76) Inventor: Michael Laiacona, Webster, NY (US)

(21) Appl. No.: 12/321,376

(22) Filed: Jan. 16, 2009

Related U.S. Application Data
(60) Provisional application No. 61/011,273, filed on Jan. 16, 2008.

(51) Int. Cl. H02G 3/18; H02G 1/00

(52) U.S. Cl. 174/59; 29/525.08

(57) ABSTRACT

This interface system for use in facilitating the mounting of flat panels for electronic media junctures/connectors uses an interface element intermediate the flat panel for electronic connectors, which would typically be mounted directly to an ambient surface such as a wall (or to an electrical box in the wall), and such wall or electrical box. The key features of the interface element are (a) a flat panel interface surface by which a flat panel can be attached to the mounting interface element, (b) side walls that inset the interface surface into the wall (or electrical box) so that the junctures and other attachments and features on the flat panel are below the ambient wall surface, and (c) a peripheral flange for connection of the interface to the ambient surface and/or the exterior of the electrical box.

### CROSS-REFERENCE TO RELATED APPLICATIONS

This application claims an invention that was disclosed in U.S. Provisional Application No. 61/011,273, filed 16 Jan. 2008, entitled “Flat Panel Mounting Interface Element, System and Method”. The benefit under 35 USC §119(e) and/or other applicable law of the aforesaid United States provisional application is hereby claimed, and the aforementioned application is hereby incorporated herein by reference.

### BACKGROUND AND SUMMARY

This invention pertains to the field of wall-mounted flat panels such as those used for mounting and ready access to electronic media connection junctures. More particularly, it describes an interface element, system and method for use in facilitating the mounting of such flat panels to a wall and/or in electrical boxes mounted in walls, in maintaining electronic media connection junctures in such flat panels below the ambient wall surface, and in creating a pleasing and finished appearance where such flat panels are used.

Wall mounted electronic media connection junctures (“connectors”) for connection of computer cords/cables, video cords/cables, audio cords/cables and the like have become ubiquitous in government, commercial, entertainment, and even church and home settings. Increasingly, as society becomes more heavily invested in the use of electronic equipment, computers and media at all levels, the numbers and types of such junctures have continued to multiply as has the use of flat panels for mounting and organizing large numbers of junctures in a single location for ease of access and use. The inclusion of cables and wires associated with media connection junctures in walls and the mounting of connectors for ease of access on wall surfaces by flat panel or individually has reduced the inconvenience, awkwardness, and danger presented by having such cables and wires exposed, where they can be damaged, tripped over, and present an ugly unfinished appearance. However, the mounting of junctures at and on wall surfaces individually or by flat panel such that the junctures extend into the space used for human traffic, furnishings, and other uses creates a similar problem. Such junctures are, like exposed cables, capable of being damaged and causing damage. They can tear clothing and fabrics, injure people and furnishings, and are subject to damage with consequent expense and risk of damage to persons and property.

The aforesaid problems led me to develop and invent the flat panel mounting interface element, system and method described herein. The interface element of my invention serves as an interface between a flat panel for electronic connectors, which would typically be mounted directly to a wall or to an electrical box in a wall, and such wall or electrical box. The key features of my mounting interface element are: (a) a flat panel interface surface by which a flat panel can be attached to the mounting interface element; (b) side walls that inset the interface surface into the wall or electrical box so that the junctures and other attachments and features on the flat panel are at least at, or preferably below, the ambient surface, and (c) a peripheral flange for connection of the interface element to the ambient surface and/or the exterior of an electrical box.

### BRIEF DESCRIPTION OF THE DRAWINGS

FIG. 1A provides a perspective view of a first interface element in accordance with the teachings of the instant invention.

FIG. 1B provides a perspective view of the interface element of FIG. 1A in combination with a flat panel bearing electronic junctures in accordance with the teachings of the instant invention.

FIG. 1C provides a perspective view of the interface element of FIG. 1A in combination with a different flat panel bearing electronic junctures in accordance with the teachings of the instant invention.

FIG. 2A provides a perspective view of a second interface element in accordance with the teachings of the instant invention.

FIG. 2B provides a perspective view of the interface element of FIG. 2A in combination with a flat panel bearing electronic junctures in accordance with the teachings of the instant invention.

FIG. 3A provides a perspective view of a third interface element in accordance with the teachings of the instant invention.

FIG. 3B provides a perspective view of the interface element of FIG. 3A in combination with a flat panel bearing electronic junctures in accordance with the teachings of the instant invention.

FIG. 4A provides a perspective view of a fourth interface element in accordance with the teachings of the instant invention.

FIG. 4B provides a perspective view of the interface element of FIG. 4A in combination with a flat panel bearing electronic junctures in accordance with the teachings of the instant invention.

FIG. 4C provides a perspective view of the interface element of FIG. 4A in combination with a flat panel bearing electronic junctures and an ambient wall surface in accordance with the teachings of the instant invention.

FIG. 4D provides an exploded perspective view of the combination of FIG. 4C.

FIG. 5A provides a perspective view of electrical boxes in accordance with the teachings of the instant invention.

FIG. 5B provides a perspective view of electrical boxes in combination with interface elements in accordance with the teachings of the instant invention.

FIG. 5C provides a perspective view of electrical boxes in combination with interface elements and a flat panel bearing electronic junctures in accordance with the teachings of the instant invention.

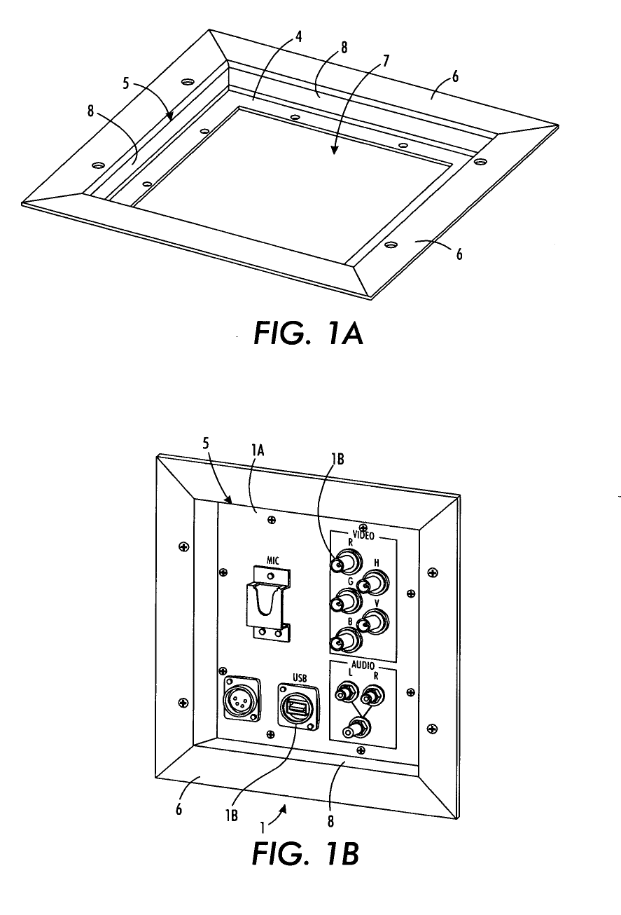

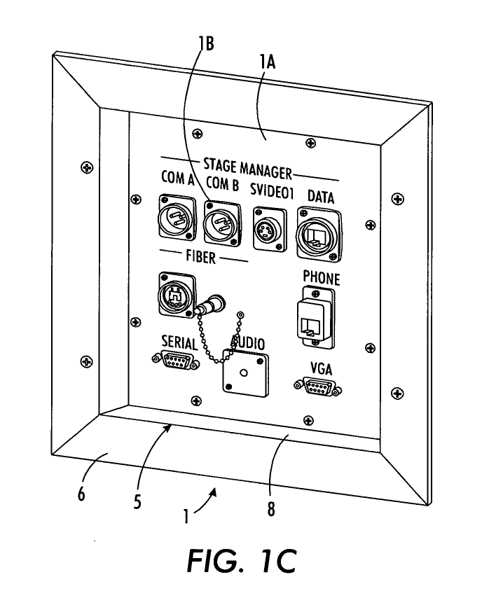

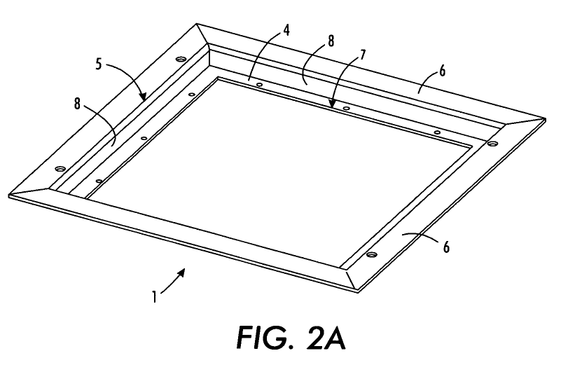

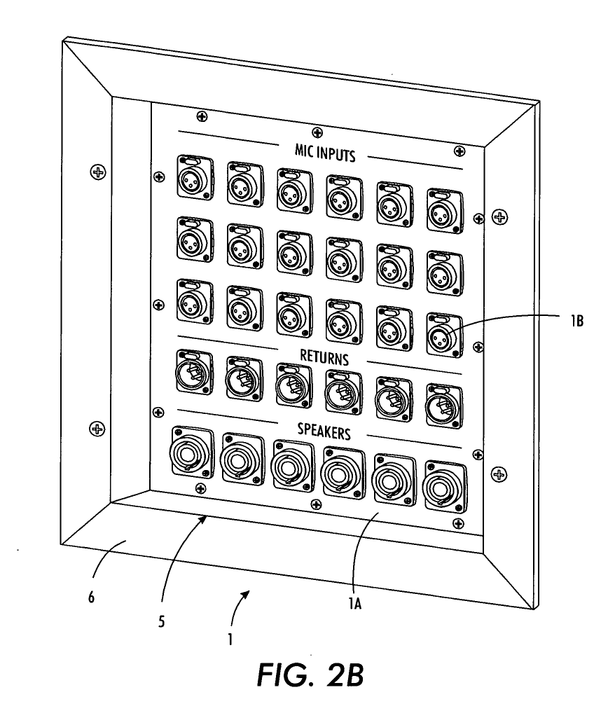

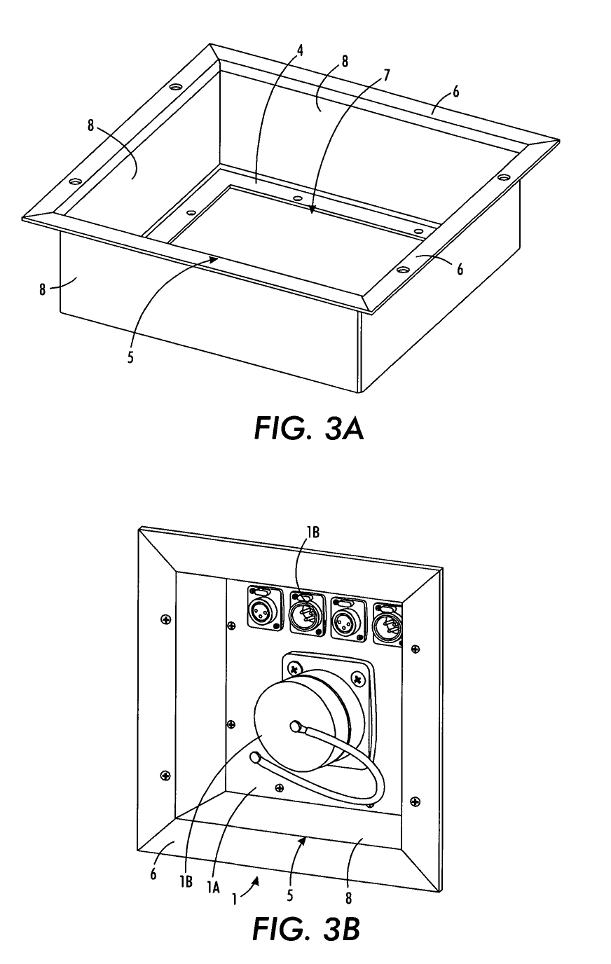

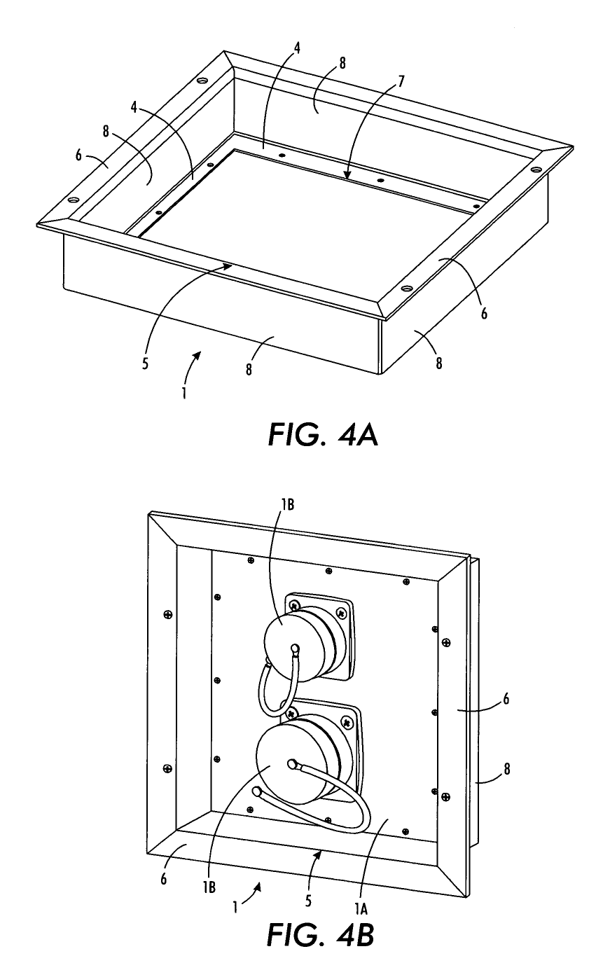

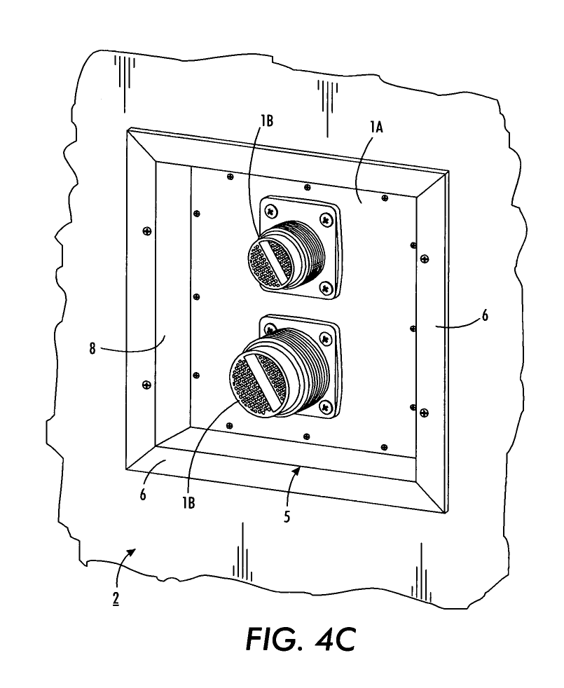

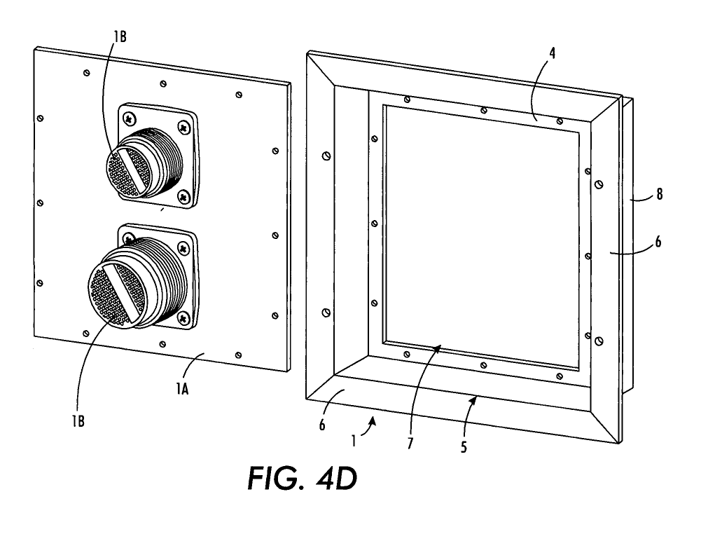

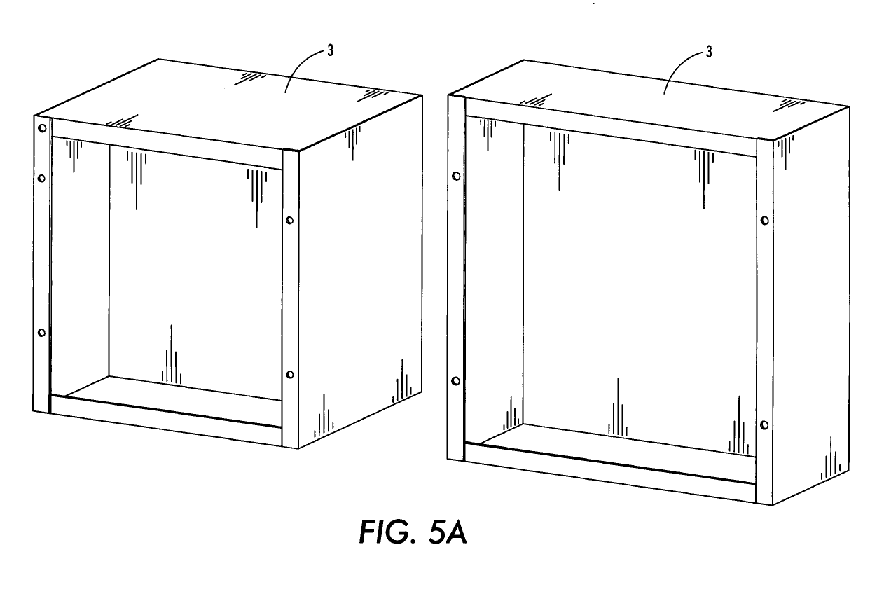

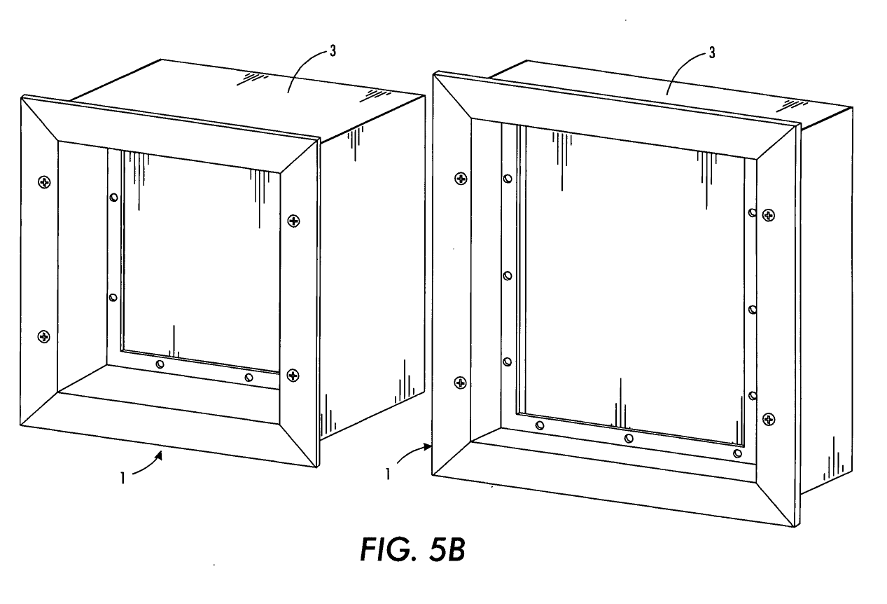

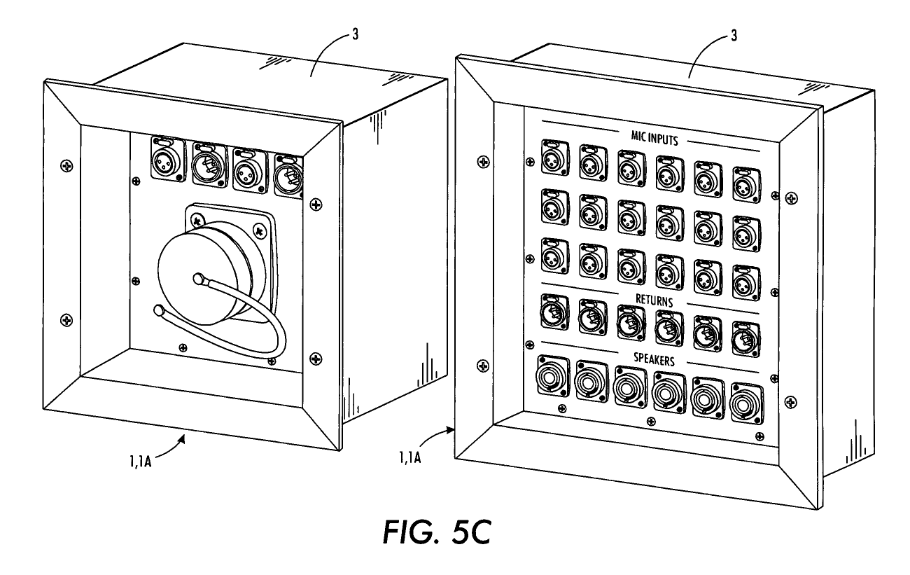

### DESCRIPTION

As can be seen from the drawing figures, the interface element (denoted generally by arrow 1) of my flat panel mounting interface system is well adapted for attachment of a flat panel 1A in an opening into the interior of an ambient surface 2 or an opening into the interior of an electrical box 3 set in the said ambient surface 2. In its most basic embodiments it includes: (a) a flat panel attachment member 4 by which a flat panel 1A including an electronic media access juncture(s) 1B can be attached to the mounting interface element 1; (b) an exterior access opening 5 by which any such flat panel 1A attached to the mounting interface element 1 can be accessed from an exterior of the ambient surface 2 or electrical box 3; (c) a mounting member 6 for connection of the interface element to at least one of any such ambient surface 2 or electrical box 3; (d) an interior access opening 7 by which a cable, wire or other line can be attached to any such electronic media access juncture(s) 1B; and (e) spacing members 8 intermediate the interior access opening 7 and the exterior access opening 5 that serve to inset the flat panel attachment member 4 and any such flat panel 1A attached thereto into the ambient surface 2 or electrical box 3 when the interface element 1 is mounted thereto via the mounting member 6.

In the preferred embodiments of my invention illustrated, the mounting member 6 is adapted to overlap an exterior region of the ambient surface 2 or electrical box 3 peripheral of the opening into the interior of said ambient surface 2 or electrical box 3, and thereby serves to cover the rough edges of either or both and create a pleasing finished appearance. Likewise, the flat panel attachment member 4 is adapted to underlie and support a peripheral region of any such flat panel 1A connected thereto and thereby. Thus, in the preferred embodiments illustrated, the mounting member 6 is a planar flange type member adjacent to and surrounding the exterior access opening 5, and the flat panel attachment member 4 is also a planar member adjacent to and surrounding the interior access opening 7. Further, in keeping with both the overall protective function and cosmetic purposes of the invention, the spacing members 8 are, likewise, formed as planar wall members intermediate and extending between the mounting member 6 and the attachment member 4.

In addition, when viewed as an overall system, my invention can also be considered to include the flat panel 1A for electronic media access juncture(s) 1B attached to the mounting interface element 1, and at least one of: an ambient surface 2 to which the interface element 1 is connected via mounting member 6, and an electrical box 3 with the interface element 1 being connected either to said electrical box 3 or wall 2 via said mounting member 6. Further, as a method, my invention would include provision of the interface element 1, mounting of a flat panel 1A thereto via attachment member 4, and mounting of the interface element to an ambient surface 2 or an electrical box 3 in said ambient surface 2 via mounting member 6, with it being understood that the order of the last two steps can be varied as necessary in the circumstances. Thus, as will be appreciated, many of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A flat panel mounting interface element for use in attachment of a flat panel in an opening into an interior of an ambient surface or an opening into an interior of an electrical box set in an ambient surface, comprising:
a flat panel attachment member by which a flat panel including an electronic media access juncture can be attached to the mounting interface system;
an exterior access opening by which any such flat panel attached to the mounting interface can be accessed from an exterior of said ambient surface or electrical box;
a mounting member for connection of the interface system to at least one of any such ambient surface or electrical box;
an interior access opening by which a cable, wire or other line can be attached to any such electronic media access juncture; and
spacing members intermediate the interior access opening and the exterior access opening that serve to inset the flat panel attachment member and any such flat panel attached thereto in any such opening into an interior of any such ambient surface or electrical box when the interface system is mounted thereto via the mounting member.

2. The flat panel mounting interface element set forth in claim 1, wherein the mounting member is adapted to overlap an exterior region of any such ambient surface or electrical box peripheral of the opening into the interior of said ambient surface or electrical box.

3. The flat panel mounting interface element set forth in claim 1, wherein the flat panel attachment member is adapted to underlie a peripheral region of any such flat panel connected thereto.

4. The flat panel mounting interface element set forth in claim 2, wherein the flat panel attachment member is adapted to underlie a peripheral region of any such flat panel connected thereto.

5. The flat panel mounting interface element set forth in claim 1, wherein at least one of the mounting member is a planar member adjacent to and surrounding the exterior access opening, the flat panel attachment member is a planar member adjacent to and surrounding the interior access opening, and the spacing members are planar members intermediate the mounting member and the attachment member.

6. The flat panel mounting interface element set forth in claim 1, wherein at least one of: the mounting member is a planar member adjacent to and surrounding the exterior access opening and adapted to overlap an exterior region of any such ambient surface or electrical box peripheral of the opening into an interior of said ambient surface or electrical box, the flat panel attachment member is a planar member adjacent to and surrounding the interior access opening and adapted to underlie a peripheral region of any such flat panel connected thereto, and the spacing members are planar members intermediate the mounting member and the attachment member.

7. A flat panel mounting interface system for use in attachment of a flat panel in an opening into an interior of an ambient surface or an opening into an interior of an electrical box set in an ambient surface, comprising.
an interface element comprising a flat panel attachment member by which a flat panel including an electronic media access juncture can be attached to the mounting interface system, an exterior access opening by which any such flat panel attached to the mounting interface can be accessed from an exterior of said ambient surface or electrical box, a mounting member for connection of the interface system to at least one of any such ambient surface or electrical box, an interior access opening by which a cable, wire or other line can be attached to any such electronic media access juncture, and spacing members intermediate the interior access opening and the exterior access opening that serve to inset the flat panel attachment member and any such flat panel attached thereto in any such opening into an interior of any such ambient surface or electrical box when the interface system is mounted thereto via the mounting member; and
at least one of a flat panel for an electronic media access juncture attached to the mounting interface, an ambient surface with the interface system being connected to said ambient surface via said mounting member, and an ambient surface and an electrical box with the electrical box set in the ambient surface and the interface system being connected to said electrical box via said mounting member.

8. The flat panel mounting interface system set forth in claim 7, wherein at least one of: the mounting member is a planar member adjacent to and surrounding the exterior access opening and adapted to overlap an exterior region of any such ambient surface or electrical box peripheral of the opening into an interior of said ambient surface or electrical box, the flat panel attachment member is a planar member adjacent to and surrounding the interior access opening and adapted to underlie a peripheral region of any such flat panel connected thereto, and the spacing members are planar members intermediate the mounting member and the attachment member.

9. A method for mounting a flat panel in an opening into an interior of an ambient surface or an opening into an interior of an electrical box set in an ambient surface, comprising:
providing an interface element comprising a flat panel attachment member by which a flat panel including an electronic media access juncture can be attached to the mounting interface system, an exterior access opening by which any such flat panel attached to the mounting interface can be accessed from an exterior of said ambient surface or electrical box, a mounting member for connection of the interface system to at least one of any such ambient surface or electrical box, an interior access opening by which a cable, wire or other line can be attached to any such electronic media access juncture, and spacing members intermediate the interior access opening and the exterior access opening that serve to inset the flat panel attachment member and any such flat panel attached thereto in any such opening into an interior of any such ambient surface or electrical box when the interface system is mounted thereto via the mounting member;
mounting at least one of a flat panel for an electronic media access juncture to the mounting interface, and said mounting member to an ambient surface or an electrical box; and
mounting the other of said flat panel for an electronic media access juncture to the mounting interface, and said mounting member to an ambient surface or an electrical box.

10. The flat panel mounting method of claim 9, wherein at least one of: the mounting member is a planar member adjacent to and surrounding the exterior access opening and adapted to overlap an exterior region of any such ambient surface or electrical box peripheral of the opening into an interior of said ambient surface or electrical box, the flat panel attachment member is a planar member adjacent to and surrounding the interior access opening and adapted to underlie a peripheral region of any such flat panel connected thereto, and the spacing members are planar members intermediate the mounting member and the attachment member.

11. The flat panel mounting interface element set forth in claim 1, wherein the spacing members that inset the interface surface into any such ambient surface or electrical box when the system is mounted thereto via the mounting member have a depth sufficient to assure that any electronic media access junctures and other attachments and features on the flat panel are not above the ambient wall surface.

12. The flat panel mounting interface element set forth in claim 6, wherein the spacing members that inset the interface surface into any such ambient surface or electrical box when the system is mounted thereto via the mounting member have a depth sufficient to assure that any electronic media access junctures and other attachments and features on the flat panel are not above the ambient wall surface.

13. The flat panel mounting interface system set forth in claim 7, wherein the spacing members that inset the interface surface into any such ambient surface or electrical box when the system is mounted thereto via the mounting member have a depth sufficient to assure that any electronic media access junctures and other attachments and features on the flat panel are not above the ambient wall surface.

14. The flat panel mounting interface system set forth in claim 8, wherein the spacing members that inset the interface surface into any such ambient surface or electrical box when the system is mounted thereto via the mounting member have a depth sufficient to assure that any electronic media access junctures and other attachments and features on the flat panel are not above the ambient wall surface.

15. The flat panel mounting method set forth in claim 9, wherein the spacing members that inset the interface surface into any such ambient surface or electrical box when the system is mounted thereto via the mounting member have a depth sufficient to assure that any electronic media access junctures and other attachments and features on the flat panel are not above the ambient wall surface.

16. The flat panel mounting method set forth in claim 10, wherein the spacing members that inset the interface surface into any such ambient surface or electrical box when the system is mounted thereto via the mounting member have a depth sufficient to assure that any electronic media access junctures and other attachments and features on the flat panel are not above the ambient wall surface.
